(19) United States
(12) Patent Application Publication
(10) Pub. No.: US 2003/0144777 A1
(43) Pub. Date: Jul. 31, 2003

(54) System and method for monitoring the vehicle dynamics of a motor vehicle

(76) Inventor: Johannes Schmitt, Markgroewningen (DE)

Correspondence Address: KENYON & KENYON, ONE BROADWAY, NEW YORK, NY, 10004, US

(21) Appl. No.: 10/220,536

(22) PCT Filed: Dec. 20, 2001
(86) PCT No.: PCT/DE01/04827

(30) Foreign Application Priority Data
Dec. 30, 2000 (DE) 10065770.2

(51) Int. Cl. G06F 7/00

(52) U.S. Cl. 701/29; 701/35

(57) ABSTRACT

A system for monitoring the driving behavior of a motor vehicle having at least one wheel (12) includes a sensor device (20, 22, 24, 26, 28, 30), assigned to the at least one wheel (12), which registers at least one wheel variable of the wheel (12) in question and emits a signal (Si, Sa) representing the at least one wheel variable, and also includes an assessment device (14) which processes the signal (Si, Sa) representing the at least one wheel variable of the wheel (12). According to the present invention, the assessment device (14) ascertains at least one characteristic value characterizing the force transmitting capability of the at least one wheel (12), according to the result of the processing. The present invention also relates to a method for monitoring the driving behavior of a motor vehicle having at least one wheel (12).

The present invention relates to a system for monitoring the operating behavior of a motor vehicle having at least one wheel, the system including a sensor device assigned to the at least one wheel, which records at least one wheel size of the respective wheel and emits a signal representing the at least one wheel size, and further including an assessment device which processes the signal.

The present invention also relates to a method for monitoring the operating behavior of a motor vehicle having at least one wheel, preferably for implementation by a system according to the present invention, which includes the steps of recording at least one wheel variable of a wheel, and the processing of at least one wheel variable.

### BACKGROUND INFORMATION

Driving dynamics regulating systems are known from the related art which influence the driving condition of a motor vehicle, either with the aid of vehicle models or slip-dependently, using control actions, in order to achieve as great as possible a force transmission between the vehicle wheels and the driving foundation or stabilization of the driving condition of the motor vehicle. Such control actions may be a change in the wheel brake pressure at one or more wheels and/or a change in the engine output.

The force transmission conditions prevailing between wheel and driving foundation are a function, in this instance, of various parameters, such as the wheel type, or rather tire type used: for example, whether summer or winter tires, the condition of the driving foundation, such as whether it is dry, wet or iced over, and also of the wheel temperature and the wheel speed. In order to make possible as accurate as possible a driving dynamics regulation, the driving dynamics regulating systems are adjusted to the exterior circumstances prevailing in each case.

In this context, a driving dynamics regulating system and method are known from the related art which use a single-track model. In such a single-track model, the force transmitting conditions prevailing between wheel, or rather tire and driving foundation enter into the differential equations describing the model as slip angle rigidities.

According to one specific embodiment of the method of the related art, the slip angle rigidities are determined by detecting and processing of the yawing motion, the sideslip angle, the vehicle's longitudinal speed, the front wheel steering angle and, if the rear wheels are steerable, the rear wheel steering angles too. In this connection, the variables named are only recorded and processed during steady-state cornering.

According to an alternative specific embodiment of the method, a front slip angle rigidity is calculated as a function of the recorded yawing motion, the recorded vehicle longitudinal speed, the recorded front wheel steering angle and, if necessary, the recorded rear wheel steering angle and as a function of a fixedly predefined value of the rear wheel slip rigidity. In this connection too, the variables named are only recorded and processed during steady-state cornering. There, the single-track model backed by the driving dynamics regulating system is adjusted to the prevailing circumstances, with the aid of the currently determined slip angle rigidities.

In another slip-based regulating method of the related art, the wheel slip response threshold values for a drive slip regulating system and/or anti-lock system are adjusted to the conditions prevailing between the tires and the driving foundation in such a way that the drive torque is ascertained from measured vehicle operating data, under consideration of constructive relationships such as overall ratio of the drive train, and from this the utilized coefficient of friction at the driven vehicle wheels at specified or measured axle load is determined. The drive slip is also measured and with the aid of a value pair of coefficient of friction/drive slip thus formed, a coefficient of friction/wheel slip characteristic curve is selected from a plurality of such characteristic curves. An ASR and/or anti-lock system then uses the wheel slip response threshold values pertaining to the coefficient of friction/wheel slip characteristic curve selected in each case.

The drive torque made available at the driven vehicle wheels is ascertained in the known method from an engine map which reproduces the relationship between fuel supply and/or air supply and engine speed, and the overall ratio of the drive train. From the drive torque of the vehicle its traction may be concluded. Using sensors which respond to the compression position of the vehicle wheels and to the pressure in a load-leveling system, one may approximately determine the normal force acting between the wheel contact surface and the driving foundation. In this context, the ratio of traction to normal force is the utilized coefficient of friction.

Alternatively, the drive torque given off to the driven wheels may also be recorded at drive shafts, using torque sensors.

In the last named case as well, the coefficient of friction/wheel slip value pair is only determined in a specified prevailing driving situation. This driving situation is straight-ahead travel of the vehicle.

To be sure, using the known methods or systems a driving dynamics regulating system can be adjusted to the conditions prevailing between vehicle wheels and driving foundation, but this requires a considerable effort in measuring technique. In addition, capturing the necessary variables required for an assessment of the conditions prevailing between the wheels and the driving foundation is possible only in certain driving situations.

In connection with the sensors of this type provided, it is also known that different tire manufacturers are planning on the future use of so-called intelligent tires. With these, new sensors and evaluating circuits may be mounted directly on the tire evaluation circuit. The use of such tires allows additional functions, such as the measurement of the torque at the tire, transversely and lengthwise to the direction of travel, of tire pressure or of tire temperature. In this connection, for example, tires may be provided where in each tire magnetized areas or strips are incorporated, preferably having field lines running in the circumferential direction.

The magnetization is carried out in sections, for instance, always in the same direction, but having opposite orientations, i.e. having alternate polarity. The magnetized strips preferably run in the rim flange area and in the tire contact area. Therefore, the measured value detectors rotate at wheel speed. Corresponding measuring sensors are preferably mounted fixed to the body at two or more points different in the rotational direction, and are also at a different radial distance from the axis of rotation. In this manner, an inner measuring signal and an outer measuring signal may be obtained. Rotation of the tire may then be detected by the changing polarity of the measuring signal or the measuring signals in the circumferential direction. The wheel speed can, for example, be calculated from the tire-tread circumference and the change with time of the inner measuring signal and the outer measuring signal.

It has also been proposed before to put sensors in the wheel bearing, this setup being able to be made in the rotating as well as in the static part of the wheel bearing. For instance, the sensors may be realized as microsensors in the form of microswitch arrays. The sensors positioned at the movable part of the wheel bearing may measure, for example, forces and accelerations as well as wheel speed. These data are compared to stored base patterns or to data from a like or similar microsensor which is mounted on the fixed part of the wheel bearing.

### SUMMARY OF THE INVENTION

Compared to the related art, the generic system is further refined in that the assessment device, according to the result of the processing, ascertains a parameter characterizing the force transmitting capability of the at least one wheel.

It is advantageous in this context that the measuring technology cost for determining the at least one parameter is considerably reduced compared to the related art. Determining the characteristic parameter in any of various driving situations is also basically conceivable.

The assessment device advantageously ascertains a lateral wheel force and/or a wheel circumference force and/or center of tire contact force and/or a wheel speed of the at least one wheel from the at least one sensor signal. Thus, from the at least one signal of a sensor device, all the quantities may be ascertained which are required for ascertaining the characteristic parameter. In this connection, the center of tire contact force is a wheel force component acting orthogonally to the wheel force component, the wheel circumference force is a component acting in the center of tire contact plane and in the wheel circumference direction, and the lateral wheel force is a wheel force component orthogonal to the two components named before.

A characteristic parameter for wheels having tires, that is particularly simple to ascertain, is the tire longitudinal rigidity and/or the tire transverse rigidity. These tire rigidities may then be used in a vehicle model. Optionally, with the aid of tire rigidities, one may also conclude the nature of the tire type used and/or the relationships prevailing between the tires and the driving foundation, in particular a precise coefficient of friction/wheel slip curve.

In this context, the tire longitudinal rigidity of a driven wheel is most simple to determine from the wheel circumferential force ascertained at the driven wheel and from wheel speeds of driven and non-driven wheels of the vehicle. In this connection, the wheel longitudinal rigidity may be defined as the quotient of the wheel circumferential force (wheel longitudinal force) and the difference in the wheel speed between the driven and the non-driven wheels. Alternatively, the wheel longitudinal rigidity may also be defined as the quotient of the wheel circumferential force ascertained at the driven wheel and the drive slip. In this connection, in turn, the drive slip is derived from the ratio of the wheel speeds of the driven and the non-driven wheels in a manner known per se.

In analogous fashion, the assessment device may determine in just as simple a manner the tire transverse rigidity of a wheel from a wheel lateral force ascertained at the wheel and from wheel speeds of driven and non-driven wheels of the vehicle. In this context, the tire transverse rigidity may be the quotient of the ascertained wheel lateral force and the difference of the wheel speeds of the driven and the non-driven wheels. Alternatively, the tire transverse rigidity may also be defined as the quotient of the wheel lateral force and the drive slip.

In addition or alternatively to the above-named tire rigidities, the assessment device may also determine a value pair from utilized coefficient of friction and occurring wheel slip as the at least one parameter of the at least one wheel. Either the accuracy of the assessment of the relationship prevailing between the wheel and the driving foundation may be increased by alternate testing of wheel rigidities and the value pair, or one may conclude directly what is a valid coefficient of friction/wheel slip characteristic curve, using only the value pair.

In this context, in turn, the assessment device may determine the utilized coefficient of friction, using an extremely low computing effort, from the center of contact force and the wheel circumferential force, may determine the occurring wheel slip from the wheel speed of driven and non-driven wheels of the vehicle.

Advantageously, the system includes a memory device in which at least one parameter may be stored. In this way, the parameter may be made available for further processing or consideration.

To be sure, it is imaginable that one may determine at least approximately wheel or tire characteristic curves, using the system according to the present invention, but the computing effort, and thus the system capacity required, may be clearly reduced if predetermined wheel characteristic curves and/or predetermined response thresholds that are assigned to different wheel or tire types are stored in the memory device, preferably under further consideration of different driving foundation conditions.

Then the assessment device may select one wheel characteristic curve from the plurality of predetermined wheel characteristic curves, with the aid of the ascertained at least one characteristic curve. The wheel characteristic curves may perhaps be a family of coefficient of friction/wheel slip characteristic curves, with tire type, driving foundation condition, and the like, serving as a family of parameters.

This is favorable above all if a device for steering and/or regulation of the driving behavior of the motor vehicle is installed on the vehicle, such as an ESP system and/or an antilock system and/or an ASR system and/or an adaptive cruise control system (ACC) and/or a driving dynamics regulating system working by steering intervention and/or a driving dynamics regulating system working by wheel suspension interventions. In this context, an ACC system is a separation distance regulating system. In driving dynamically intervening steering systems (FLS) or in a “steer by wire” system, steering interventions depending on these can also take place (for example, steering angle restrictions or steering in the opposite direction). These devices can then optimally control the driving behavior of the motor vehicle with the aid of the selected wheel characteristic curve. Instead of wheel characteristic curves, merely response threshold values, such as response wheel slip threshold values, can also be stored and used.

The number of system component parts and system components may be reduced by assigning the assessment device to the control and/or regulation of the driving behavior of the motor vehicle. Above all, this includes the case where the assessment device is a part of the device mentioned.

A particularly accurate registration of the wheel variables required for computing the at least one characteristic value is made possible by a tire sensor device. In this case, the wheel variables are registered very close to the location at which they actually appear, so that interfering influences by components connected in series are largely excluded.

Alternatively, however, a wheel bearing sensor device may be used. This too makes possible an accurate registration of the wheel variables without further falsification caused by components present between the place where the wheel variables are detected and the place where their effect takes place. Both sensor types mentioned also have the advantage that they may each register center of tire contact forces, wheel circumferential forces and lateral wheel forces, as well as wheel speed.

According to the present invention, the advantages named are also obtained by a system for control and/or regulation of the driving behavior of a motor vehicle having at least one tire and/or one wheel, a force sensor being mounted in the tire and/or on the wheel, particularly at the wheel bearing, and a tire variable representing the tire rigidity being ascertained as a function of the output signals of the force sensor, and this tire variable is taken into consideration in the control and/or regulation of the driving behavior.

The present invention is refined further, compared to the method of this type, in that the method additionally includes the step of ascertaining at least one characteristic value characterizing the force transmitting capability of the respective wheel according to the result of the processing. Thus the at least one characteristic value characterizing the force transmitting capability of the respective wheel may be obtained using little processing or computing effort. By the way, in the case of the method according to the present invention, the advantages mentioned before in connection with the system description are also achieved. This is why, for a supplemental explanation of the method according to the present invention, we refer explicitly to the description of the system according to the present invention.

Advantageously, the processing step may include ascertaining a wheel lateral force and/or a wheel circumferential force and/or a center of tire contact force and/or a wheel speed according to the at least one registered wheel variable. One may thereby ascertain from the at least one wheel variable all the required variables for the optimal ascertainment of the at least one characteristic value.

In the ascertainment step, it is particularly simple to determine at least one tire rigidity, preferably a tire longitudinal rigidity and/or a tire transverse rigidity as the at least one characteristic value of the at least one wheel. The tire longitudinal rigidity of a driven wheel may be determined from the wheel circumferential force ascertained at the driven wheel and from the wheel speeds of driven and non-driven wheels of the vehicle. Analogously to this, the wheel transverse rigidity of a wheel may be determined from the wheel lateral force ascertained at the wheel and from the wheel speeds of driven and non-driven wheels of the vehicle.

After that, the determined wheel rigidity may be used in a vehicle model, and thus may be used for its updating. Alternatively or additionally to this, one may conclude the nature of the tire type and/or the condition of the driving foundation and/or the tire temperature with the aid of the determined tire rigidity. Because of that, with the aid of the determined tire rigidity, one may also come to a conclusion on threshold values such as response wheel slip threshold values for driving dynamics regulations.

In the ascertainment step, alternatively or additionally to tire rigidity, one may also determine a value pair from utilized coefficient of friction and the occurring wheel slip as the at least one characteristic value of the at least one wheel. Using such a value pair, one may come to a conclusion directly on a coefficient of friction/wheel slip characteristic curve and thus on appertaining response wheel slip threshold values.

The coefficient of friction may be determined in an especially simple manner from the center of tire contact force and the wheel circumferential force. The occurring wheel slip may be determined from the wheel speed of the driven and non-driven wheels of the vehicle.

As was described before, in order to increase traffic safety, one may give consideration to the ascertained at least one characteristic value when it comes to control and/or regulation of the vehicle behavior of a motor vehicle, as, for instance, by an ESP method and/or an antilock method and/or an ASR method and/or a mechanical steering method and/or an ACC method and/or a driving dynamics regulation method working on the basis of steering intervention and/or a driving dynamics regulation method working on the basis of wheel suspension intervention.

This consideration may be given in such a way that control and/or regulation of the driving behavior of a motor vehicle is adjusted as a function of the at least one ascertained characteristic value, preferably by selecting one of a plurality of predetermined wheel characteristic curves and/or one of a plurality of predetermined response thresholds.

The at least one wheel variable is advantageously registered at a tire of the wheel, in order to improve thereby the accuracy of the registration result. Registration at a wheel bearing also yields very good results.

In one advantageous further development of the present invention, the tire rigidities determined according to the present invention may be filtered in a suitable form, so as to exclude interfering influences from the driving foundation, such as washboard road surfaces driven over or puddles driven through.

### BRIEF DESCRIPTION OF THE DRAWINGS

The present invention is explained in greater detail below, with the aid of the appropriate drawings.

The figures show:

FIG. 1 a part of a tire outfitted with a tire sidewall sensor;

FIG. 2a exemplary rectangular signal patterns of the tire sidewall sensor shown in FIG. 1;

FIG. 2b exemplary sinusoidal signal patterns of the tire sidewall sensor shown in FIG. 1;

FIG. 3 a flow diagram of a first embodiment of the method according to the present invention;

FIG. 4 a flow diagram of a second embodiment of the method according to the present invention;

FIG. 5 a wheel force/wheel slip characteristic curve; and

FIG. 6 a family of coefficient of friction/wheel slip characteristic curves.

### DESCRIPTION OF THE EXEMPLARY EMBODIMENTS

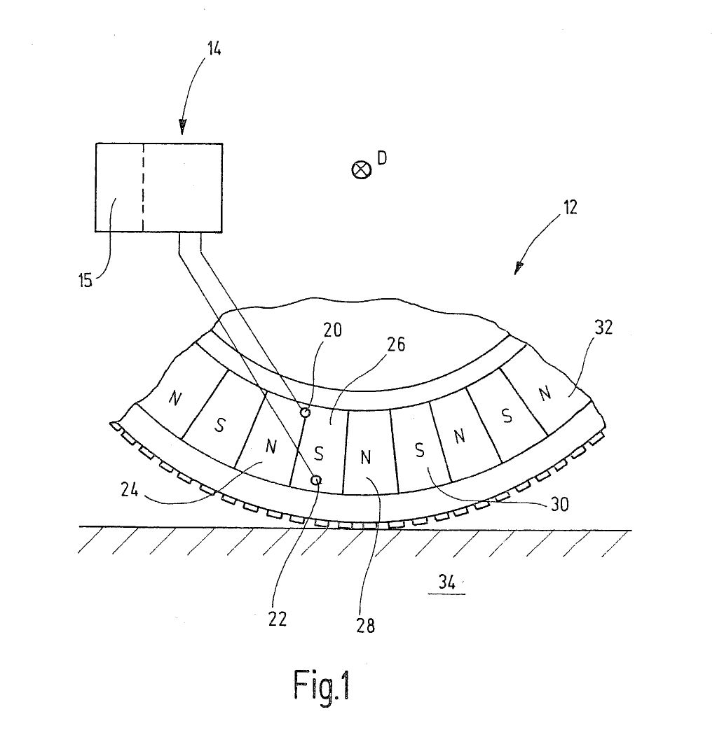

FIG. 1 shows a wheel 12, an assessment device 14 having a memory device 15 and particularly a section of a tire 32, mounted on the wheel 12, having a so-called tire/sidewall sensor device 20, 22, 24, 26, 28, 30 as seen in the direction of the axis of rotation D of wheel 12. Tire/sidewall sensor device 20 includes two sensor devices 20, 22, which are body-mounted at two points different in the rotational direction. Furthermore, the sensor devices 20, 22 each have different radial distances from the axis of rotation of wheel 32. The sidewall of tire 32 is furnished with a plurality of magnetized areas, running essentially in the radial direction with respect to the wheel's axis of rotation, as measurement transducers 24, 26, 28, 30 (strips), preferably having field lines running in the circumferential direction. The magnetized areas have alternate magnetic polarity.

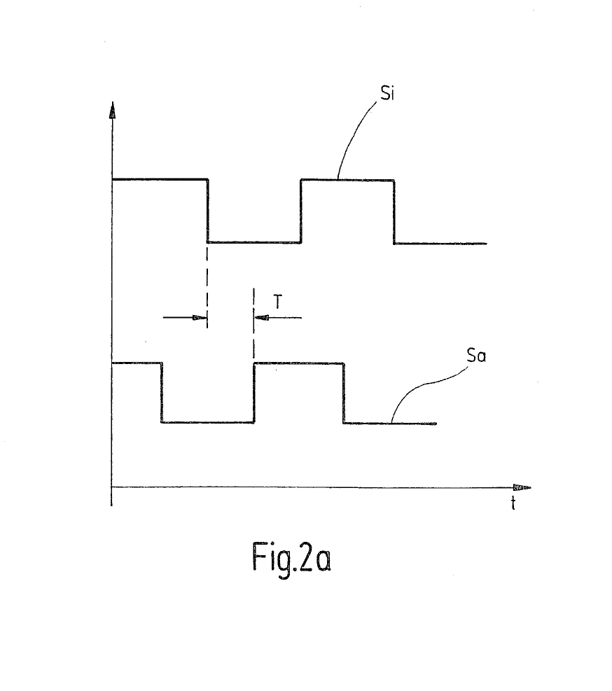

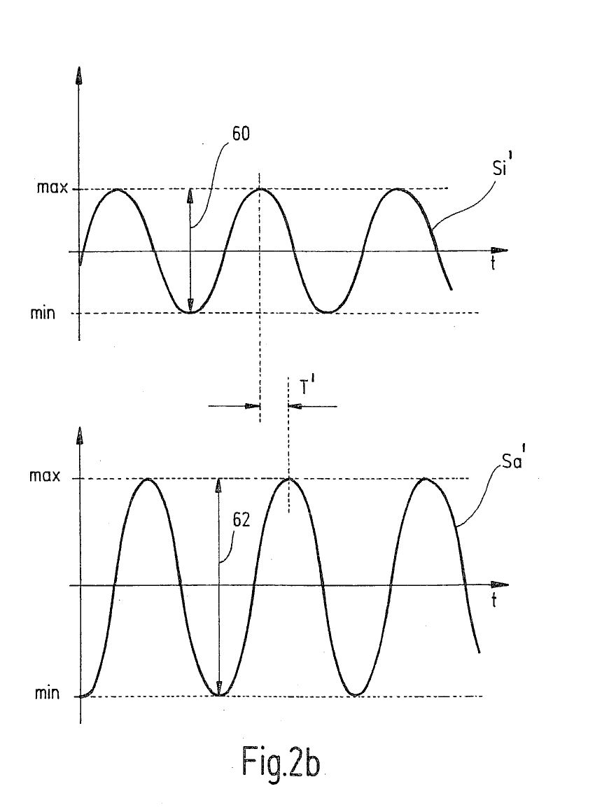

FIG. 2a shows schematically the patterns of a signal Si, transformed into a rectangle, of sensor device 20 positioned inside, that is, closer to axis of rotaion D of wheel 12 according to FIG. 1 and the patterns of a signal Sa, transformed into a rectangle, of sensor device 22 positioned outside, that is farther away from axis of rotation D of wheel 12 according to FIG. 1. Rotation of tire 32 is detected via the changing polarity of measuring signals Si and Sa. From the tire tread circumference and the change with time of signals Si and Sa, for example, the wheel speed may be calculated. By a phase shift T between the signals, deformations such as torsions in tire 32 may be ascertained, and thus direct wheel forces may be measured. Information about the transverse force appearing at the tires may be reached via the signal amplitude difference of the two signals. The signal amplitude difference is reduced when the air gap between tire and sensor is increased.

FIG. 2b shows sinusoidal signals Si′ and Sa′ originally received from sensor devices 20 and 22. Here, amplitude ΔSi′ of signal Si′ signal is denoted by reference numeral 60, and amplitude ΔSa′ of signal Sa′ is denoted by reference numeral 62. As may be seen in FIG. 2a, there is a difference between signal amplitudes 60 and 62. This difference is a measure for the transverse force appearing at the tire. Generally, a signal amplitude is calculated according to the following equation:

ΔSx′=Sx′(max)−Sx′(min), x being equal to i or a.

In addition, between signals Si′ and Sa′ shown in FIG. 2, there is also a phase difference T′.

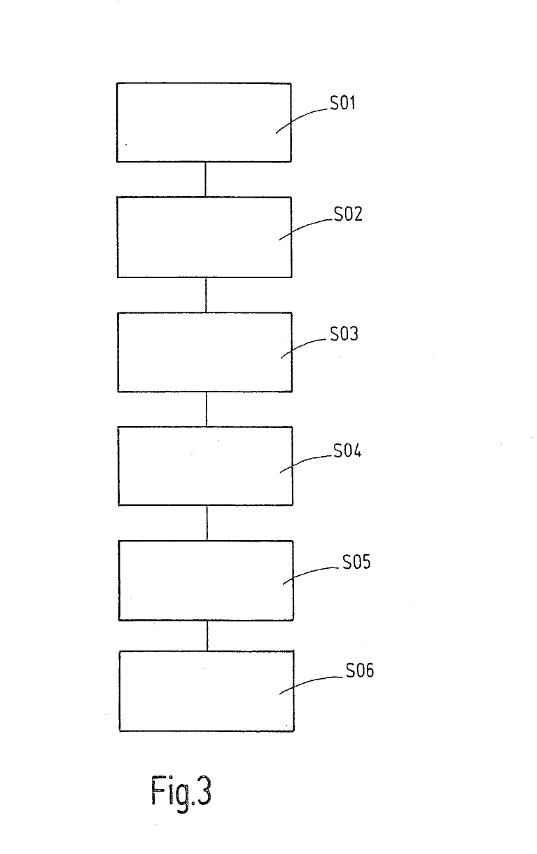

FIG. 3 shows a flow diagram of a first embodiment of the method according to the present invention within the framework of the present invention. It represents the ascertainment of a longitudinal rigidity and a subsequent correction of a driving dynamics regulating system. First, the meaning of the individual steps is given:

S01: registering a deformation of wheels by the sensor device.

S02: ascertaining a wheel circumferential force of the wheels on the driving foundation from the registered deformation.

S03: registering of wheel speeds of driven and non-driven wheels.

S04: determining slip from the wheel speeds of the driven and non-driven wheels.

S05: determining the tire longitudinal rigidity.

S06: substituting the determined tire longitudinal rigidity in a vehicle model of a driving dynamics regulating system.

The process sequence shown in FIG. 3 can take place this way, or in a similar way in a rear-wheel or a front-wheel driven vehicle. In step S01, for example, a tire deformation of wheels in the circumferential direction is registered.

In step S02, wheel circumferential forces are ascertained from the deformations. This is done, for instance, using characteristic curves stored in a memory unit, which give the relationship of deformation to wheel circumferential force.

Additionally, in step S03, wheel speeds or wheel rotational speeds of driven and non-drive wheels are registered.

In step S04, the current wheel slip is determined from the wheel speeds ascertained in step S03. Then, in step S05, the tire longitudinal rigidity is calculated from the quantities ascertained or determined in steps S02 and S04. The exact method of calculation is described below in greater detail.

Subsequently, in step S06, the ascertained tire longitudinal rigidity is substituted into a vehicle model of a driving dynamics regulating system. If the vehicle model is, for instance, a single-track model, the differential equations described by the model may be solved using the updated tire longitudinal rigidity, and thus they yield a result adjusted to the current driving situation.

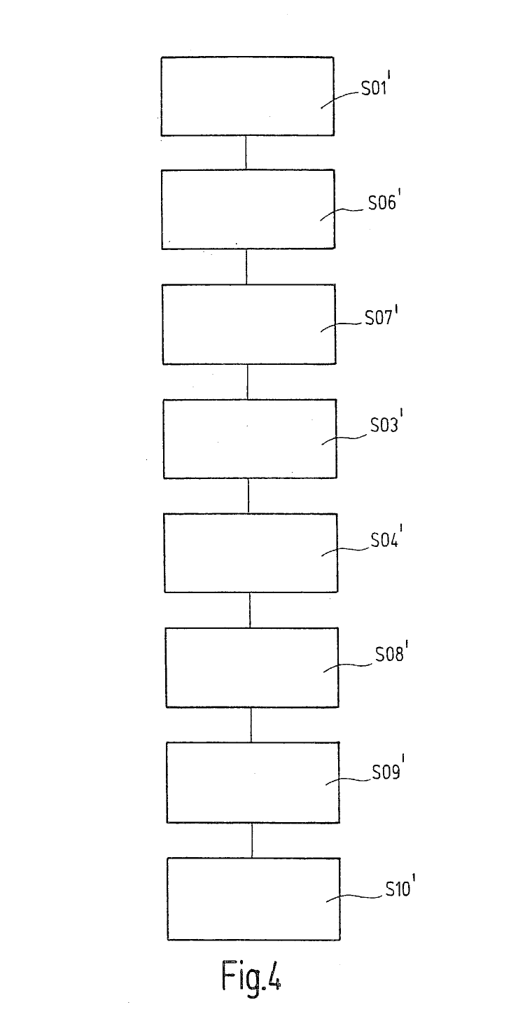

FIG. 4 shows a flow diagram of a second embodiment of the method according to the present invention. It represents the ascertainment of a coefficient of friction/wheel slip value pair and a subsequent correction of a driving dynamics regulating system. The steps of the alternative method are given primed reference numerals. The same method steps as in FIG. 3 are marked with the same numbers. First, the meaning of the individual steps is again given:

S01′: registering a deformation of wheels by the sensor device.

S06′: ascertaining a center of tire contact force and a wheel circumferential force of the wheels from the deformation registered.

S07′: determining the utilized coefficient of friction from the center of tire contact force and the wheel circumferential force.

S03′: registering of wheel speeds of driven and non-driven wheels.

S04′: determining slip from the wheel speeds of the driven and non-driven wheels.

S08′: determining a coefficient of friction/wheel slip value pair.

S09′: selecting a coefficient of friction/wheel slip characteristic curve and a family of such characteristic lines.

S10′: using the selected coefficient of friction/wheel slip characteristic line in a driving dynamics regulating system.

Below, only those steps of the alternative method are explained, which differ from the method steps as in FIG. 3.

Step S06′ corresponds essentially to step S02, only, in addition to the wheel circumferential force, the center of tire contact force is also ascertained. The utilized coefficient of friction is determined from these forces in step S07′.

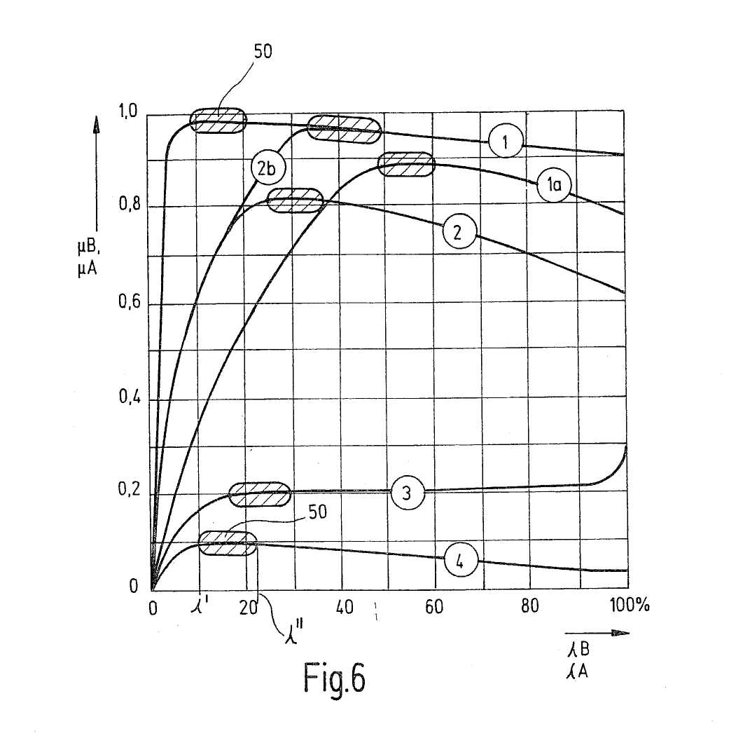

The coefficient of friction and the wheel slip determined are then combined in step S08′ to a coefficient of friction/wheel slip value pair. In the light of this value pair, in step S09′ a coefficient of friction/wheel slip characteristic curve is selected from a family of coefficient of friction/wheel slip characteristic curves as is shown, for example, in FIG. 6. This selected characteristic curve is finally used in step S10′ in a driving dynamics regulating system.

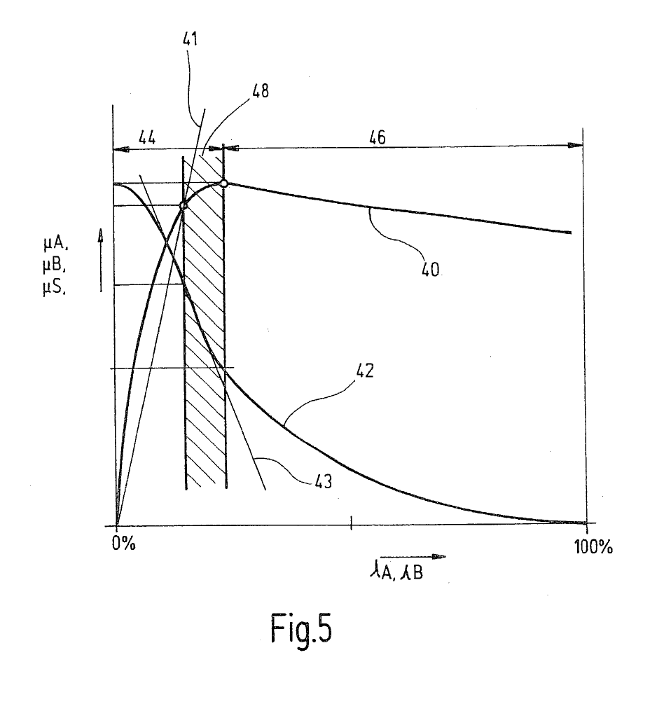

FIG. 5 shows curves giving the relationship between braking force and lateral force of a wheel and the wheel slip occurring at the wheel. In this context, the abscissa gives the driven wheel slip A and the braking wheel slip B, the left end of the abscissa (0% wheel slip) representing the state of an ideally rolling wheel, and the right end of the abscissa (100% wheel slip) representing a completely locked wheel.

Here, driven wheel slip A and braked wheel slip B are defined as follows:

$$\begin{matrix}λ A = ( 1 - \frac{{v}_{wheel}}{{v}_{vehicle}} ) \cdot 100 \% \\ λ B = ( \frac{{v}_{wheel}}{{v}_{vehicle}} - 1 ) \cdot 100 \%\end{matrix}$$

where v_{wheel} is the speed of a driven wheel and v_{vehicle} is the vehicle speed.

The ordinate represents the coefficients of friction μA, μB and μS, the indices A, B and S in detail representing the drive case, especially the accelerated drive, the case of braking and the case of an occurring side force. The individual coefficients of friction are given by the following equations:

$$\begin{matrix}μ A = \frac{{F}_{drive}}{{F}_{weight}} \\ μ B = \frac{{F}_{brake}}{{F}_{weight}} \\ μ S = \frac{{F}_{lateral force}}{{F}_{weight}}\end{matrix}$$

In these equations, F_{drive} is the driving force acting on a tire, F_{brake} is the braking force acting on a tire, F_{lateral force} the lateral force transmitted by a tire and F_{weight} is the force of weight transmitted by the tire to the driving foundation.

Curve 40 gives the relationship between braking force and wheel slip and curve 42 gives the relationship between lateral force and wheel slip. Straight line 41, particularly its slope, represents the characteristic value KL of force transmittability of a tire in the longitudinal direction. Similarly, straight line 43, particularly its slope, represents the characteristic value KQ of force transmittability of a tire in the transverse direction.

Reference numeral 44 denotes a stable wheel slip region, and 46 denotes an unstable wheel slip region. Region 46 counts as being unstable since in that region, at increasing wheel slip, the braking force transmittable between tire and driving foundation, and above all, the transmittable lateral force decrease, so that, in this slip region, the vehicle easily goes out of control. An anti-lock system is basically designed in such a way that the wheel slip lines up in hatched region 48. In this region, a maximum braking force between driving foundation and vehicle may be transmitted.

FIG. 6 shows a family of curves whose individual curves each represent a dependence of braking slip μB and/or drive slip μA in dependence on braking wheel slip λB or on driven wheel slip λA. In this context, the following parameters are in each case assigned to the individual curves:

1: summer tire on a dry road surface

1a. summer tire having tire slip

2: winter tire on a wet road surface

2b: winter tire on a dry road surface

3: winter tire on snow

4: winter tire on ice

Slip regulation as executed, for example, by an antilock system or an ASR system, should ideally line up the wheel slip in hatched regulating region 50, since there the greatest braking coefficient of friction or drive coefficient of friction is achieved, and thus a maximum braking force or driving force may be transmitted between tire and driving foundation.

In the light of at least one characteristic value determined according to the present invention, the curve valid for force transmitting conditions in each case may now be selected from the family of curves, and the slip threshold values λ′ and λ″ assigned thereto may be selected.

In this context, the tire longitudinal rigidity is determined as follows:

The average wheel speed of the driven wheels VMAN is determined from the wheel rotational speeds of the driven wheels and the average wheel speed of the non-driven wheels VMNA is determined from the wheel rotational speeds of the non-driven wheels. From this one may derive the rotational speed DV=VMAN−VMNA, or the wheel slip λ=(VMAN−VMNA)/VMAN. The wheel circumferential force, i.e. the wheel longitudinal force F_{L}, is ascertained by the tire sensor device and/or a wheel bearing sensor device. The wheel longitudinal rigidity K_{L} or K_{L}′ is then obtained from K_{L}=F_{L}/DV or from K_{L}′=F_{L}/λ. Analogously to this, tire transverse rigidity K_{S} is ascertained using wheel lateral force F_{S} instead of wheel longitudinal force F_{L}. Analogously, the equations K_{S}=F_{S}/DV or K_{S}′=F_{S}/λhold.

In the same manner, the utilized coefficient of friction μ may be determined from the wheel circumferential force or wheel longitudinal force F_{L} and from the center of tire contact force F_{N} likewise ascertained by a tire sensor device or a wheel bearing sensor device. Thus, the following equation is applicable: μ=F_{L}/F_{N}

Thus, in the light of a value pair (μ, λ), the curves shown in FIG. 6 and their assigned response wheel slip threshold values may be directly selected.

The preceding description of the exemplary embodiments according to the present invention is for illustrative purposes only, and is not meant to restrict the invention. Various changes and modifications are possible within the framework of the present invention, without leaving the scope of the present invention and its equivalents.

What is claimed is:

1. A system for monitoring the driving behavior of a motor vehicle having at least one wheel (12), comprising:
a sensor device (20, 22, 24, 26, 28, 30) assigned to the at least one wheel (12) which registers at least one wheel variable of the wheel (12) in question and emits a signal (Si, Sa) representing the at least one wheel variable, and
an assessment device (14) which processes the signal (Si, Sa) representing the at least one wheel variable of the wheel (12),
wherein, according to the result of the processing, the assessment device (14) ascertains at least one characteristic value characterizing the force transmitting capability of the at least one wheel (12).

2. The system as recited in claim 1,
wherein the assessment device (14) ascertains a wheel lateral force and/or a wheel circumferential force and/or a center of tire contact force and/or a wheel rotational speed of the at least one wheel (12), from the at least one sensor signal (Si, Sa).

3. The system as recited in claim 1 or 2, wherein the assessment device (14) determines a tire rigidity, preferably a tire longitudinal rigidity and/or a tire transverse rigidity, as the at least one characteristic value of the at least one wheel (12).

4. The system as recited in one of the preceding claims,
wherein the assessment device (14) determines the tire longitudinal rigidity of a driven wheel from the wheel circumferential force ascertained at the driven wheel and from the wheel rotary speeds of the driven and the non-driven wheels of the vehicle.

5. The system as recited in one of the preceding claims,
wherein the assessment device (14) determines the tire longitudinal rigidity of a wheel (12) from the wheel lateral force ascertained at the wheel (12) and from the wheel rotary speeds of the driven and the non-driven wheels of the vehicle.

6. The system as recited in one of the preceding claims,
wherein the assessment device (14) determines a value pair as the at least one characteristic value of the at least one wheel (12), from the utilized coefficient of friction and the occurring wheel slip.

7. The system as recited in one of the preceding claims,
wherein the assessment device (14) determines the utilized coefficient of friction from the center of tire contact force and the wheel circumferential force, and determines the occurring wheel slip from the wheel rotary speed of the driven and the non-driven wheels of the vehicle.

8. The system as recited in one of the preceding claims,
wherein it has a memory device (15) for storing the at least one characteristic value.

9. The system as recited in one of the preceding claims,
wherein predetermined wheel characteristic values (1, 1a, 2, 2b, 3, 4) and/or predetermined response threshold values are stored in the memory device (15), which are assigned to different wheel types or tire types, preferably along with further consideration of different driving foundation conditions.

10. The system as recited in one of the preceding claims,
wherein the assessment device (14) is assigned to a device for controlling and/or regulating the driving behavior of a motor vehicle, such as an ESP system and/or an antilock system and/or an ASR system and/or an ACC system and/or a driving dynamics regulating system working by steering interventions and/or a driving dynamics regulating system working by wheel suspension interventions.

11. The system as recited in one of the preceding claims,
wherein the sensor device (20, 22, 24, 26, 28, 30) is a tire sensor device (20, 22, 24, 26, 28, 30).

12. The system as recited in one of the preceding claims,
wherein the sensor device is a wheel bearing sensor device.

13. A system for controlling and/or regulating the driving behavior of a motor vehicle having at least one tire (32) and/or one wheel (12), a force sensor (20, 22, 24, 26, 28, 30) being mounted in the tire (32) and/or on the wheel (12), in particular on the wheel bearing, and a tire variable representing the tire rigidity being ascertained as a function of the output signals of the force sensor (20, 22, 24, 26, 28, 30) and this wheel variable is taken into consideration during the control and/or regulation of the driving behavior.

14. A system for monitoring the driving behavior of a motor vehicle having at least one wheel (12), which includes the following steps:
Registering (S01, S03; S01′, S03′) at least one wheel variable of a wheel (12), and
Processing (S02, S04; S06′, S07′, S04′) the at least one wheel variable,
wherein the method also includes the step of ascertaining (S05; S08′) at least one characteristic value characterizing the force transmitting capability of the wheel (12) in question, according to the results of the processing.

15. The method as recited in claim 14,
wherein the processing step includes ascertaining a wheel lateral force and/or a wheel circumferential force (S02; S06′) and/or a wheel center of tire contact force (S06′) and/or a wheel rotary speed (S03; S03′) according to the at least one registered wheel variable.

16. The system as recited in claim 14 or 15,
wherein in the ascertainment step (S05) at least one tire rigidity, preferably a tire longitudinal rigidity and/or a tire transverse rigidity are determined as the at least one characteristic value of the at least one wheel.

17. The method as recited in one of claims 14 through 16, wherein the tire longitudinal rigidity of a driven wheel is determined from the wheel circumferential force ascertained at the driven wheel and from the wheel rotary speeds of the driven and the non-driven wheels of the vehicle.

18. The method as recited in one of claims 14 through 17,
wherein the tire transverse rigidity of a wheel (12) is determined from the wheel lateral force ascertained at the wheel (12) and from the wheel rotary speeds of the driven and the non-driven wheels of the vehicle.

19. The method as recited in one of claims 14 through 18,
wherein a value pair is ascertained in the ascertainment step (S08′) as the at least one characteristic value of the at least one wheel (12), from the utilized coefficient of friction and the occurring wheel slip.

20. The method as recited in one of claims 14 through 19,
wherein the utilized coefficient of friction is determined from the center of tire contact force and the wheel circumferential force, and the occurring wheel slip is determined from the wheel rotary speeds of the driven and the non-driven wheels of the vehicle.

21. The method as recited in one of claims 14 through 20,
wherein the ascertained at least one characteristic value is taken into consideration (S06; S10′) in a control and/or a regulation of the driving behavior of a motor vehicle, such as by an ESP method and/or an ABS method and/or an ASR method and/or an ACC method and/or a driving dynamics regulating method working by steering interventions and/or a driving dynamics regulating method working by wheel suspension interventions.

22. The method as recited in one of claims 14 through 21,
wherein a control and/or regulation of the driving behavior of a motor vehicle is adjusted (S06; S10′) as a function of the ascertained at least one characteristic value, preferably by selecting one of a plurality of predetermined wheel characteristic curves (1, 1a, 2, 2b, 3, 4) and/or one of a plurality of predetermined response threshold values.

23. The method as recited in one of the preceding claims,
wherein the at least one wheel variable is ascertained at a tire (32) of the wheel (12).

24. The method as recited in one of the preceding claims,
wherein the at least one wheel variable is ascertained at a bearing of the wheel (12).
